(19) United States
(12) Patent Application Publication
(10) Pub. No.: US 2021/0135185 A1
(43) Pub. Date: May 6, 2021

(54) METHOD FOR LITHIUM-ION BATTERY REGENERATION

(71) Applicant: The Trustees of Indiana University, Bloomington, IN (US)

(72) Inventor: Hosop Shin, Carmel, IN (US)

(73) Assignee: The Trustees of Indiana University, Bloomington, IN (US)

(21) Appl. No.: 17/090,038

(22) Filed: Nov. 5, 2020

Related U.S. Application Data
(60) Provisional application No. 62/931,104, filed on Nov. 5, 2019.

(51) Int. Cl. H01M 4/04; H01M 4/131; H01M 4/134; H01M 4/525; H01M 4/505; H01M 4/36; H01M 10/0525

(52) U.S. Cl. CPC H01M 4/0445; H01M 4/131; H01M 4/134; H01M 10/0525; H01M 4/505; H01M 4/366; H01M 4/525

(57) ABSTRACT

A method for regenerating a cathode of a used lithium-ion battery, wherein the cathode of the used lithium-ion battery has a first level of lithium ions, the method comprising providing a pre-lithiation agent to the cathode, assembling a regenerated lithium-ion battery using the cathode with the pre-lithiation agent, and cycling the regenerated lithium-ion battery through at least one full charge event and at least one full discharge event to provide the cathode of the regenerated lithium-ion battery with a second level of lithium ions, wherein the second level of lithium ions is higher than the first level of lithium ions.

### CROSS-REFERENCE TO RELATED APPLICATION

This application claims the benefit of U.S. Provisional Patent Application No. 62/931,104, filed Nov. 5, 2019, the disclosure of which is expressly incorporated by reference herein.

### FIELD OF THE DISCLOSURE

The present disclosure relates generally to a method for regenerating a lithium battery, and more specifically, to a method for regenerating a cathode of a used lithium battery electrochemically to extend the life of the lithium battery.

### BACKGROUND OF THE DISCLOSURE

Traditional recycling or regenerating techniques for lithium-ion batteries (such as pyro-metallurgy and hydro-metallurgy) use smelting and leaching processes which eventually result in recovering valuable metals and materials where the recovered metals can be potentially used for resynthesizing new cathode active materials or for other purposes. However, these traditional recycling/regenerating techniques are neither environmentally-friendly or cost-effective. Thus, a need exists for a more environmentally-friendly and cost-effective method for regenerating lithium-ion batteries.

### SUMMARY OF THE DISCLOSURE

In one embodiment of the present disclosure, a method for regenerating a cathode of a used lithium-ion battery, wherein the cathode of the used lithium-ion battery has a first level of lithium ions, comprises providing a pre-lithiation agent to the cathode, assembling a regenerated lithium-ion battery using the cathode with the pre-lithiation agent, and cycling the regenerated lithium-ion battery through at least one full charge event and at least one full discharge event at a specific voltage window to provide the cathode of the regenerated lithium-ion battery with a second level of lithium ions, wherein the second level of lithium ions is higher than the first level of lithium ions.

In another embodiment of the present disclosure, a regenerated battery comprises a cathode having a sacrificial layer adhered to at least one surface of the cathode, an anode positioned adjacent the cathode, and a separator positioned between the anode and the cathode.

In yet another embodiment of the present disclosure, a regenerated battery comprises a cathode comprising a pre-lithiation agent, an anode positioned adjacent the cathode, and a separator positioned between the anode and the cathode.

### BRIEF DESCRIPTION OF THE DRAWINGS

The above-mentioned and other features of this disclosure and the manner of obtaining them will become more apparent and the disclosure itself will be better understood by reference to the following description of embodiments of the present disclosure taken in conjunction with the accompanying drawings, wherein:

FIG. 1 shows a schematic view of a lithium-ion battery at full capacity;

FIG. 2 shows a schematic view of the lithium-ion battery of FIG. 1 in a used condition;

FIG. 3 shows a schematic view of the lithium-ion battery of FIG. 2 recycled back to full capacity using a recycling or regenerative process of the present disclosure;

FIG. 4 shows a diagram of a first embodiment of an electrochemical-based cathode regeneration process for regenerating or recycling a lithium-ion battery of the present disclosure;

FIG. 5 shows a diagram of a second embodiment of an electrochemical-based cathode regeneration process for regenerating or recycling a lithium-ion battery of the present disclosure;

FIG. 6A shows a schematic view of a cathode and an anode of a lithium-ion battery of the present disclosure, the cathode including with a reduced amount of lithium ions and having a pre-lithiation agent present to provide additional lithium ions;

FIG. 6B shows a schematic view of the cathode and the anode of the lithium-ion battery of FIG. 6A with the lithium ions from the cathode in addition to lithium ions from the pre-lithiation agent transferred to the anode after the initial charge;

FIG. 6C shows a schematic view of the cathode and the anode of the lithium-ion battery of FIG. 6B with the lithium ions transferred back to the cathode after a discharge event such that the cathode is regenerated or recycled back to full capacity;

FIG. 7 shows a schematic view of a first embodiment of a regenerated or recycled lithium-ion battery of the present disclosure having a cathode with a full sacrificial layer and an anode separated by a separator;

FIG. 8 shows a schematic view of a second embodiment of a regenerated or recycled lithium-ion battery of the present disclosure having a cathode with a patterned sacrificial layer and an anode separated by a separator; and

FIG. 9 shows a schematic view of a third embodiment of a regenerated or recycled lithium-ion battery of the present disclosure having a cathode infused with a pre-lithiation agent infused and an anode separated by a separator.

### DETAILED DESCRIPTION OF EMBODIMENTS

The embodiments disclosed herein are not intended to be exhaustive or to limit the disclosure to the precise forms disclosed in the following detailed description. Rather, the embodiments were chosen and described so that others skilled in the art may utilize their teachings.

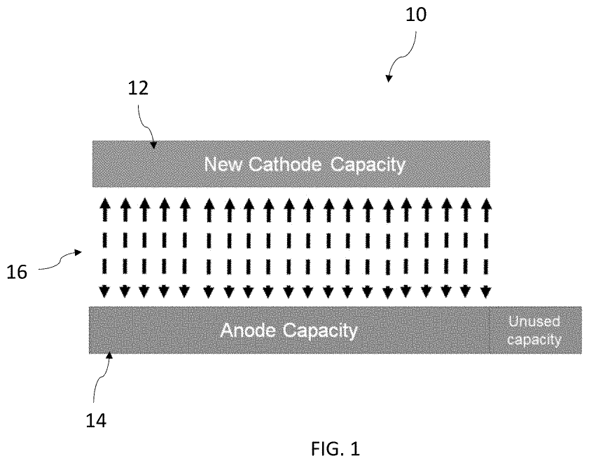

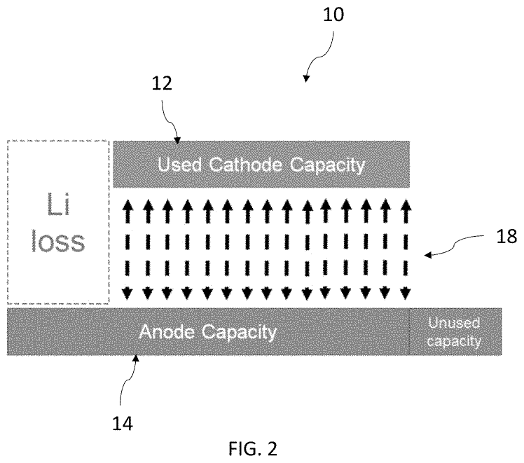

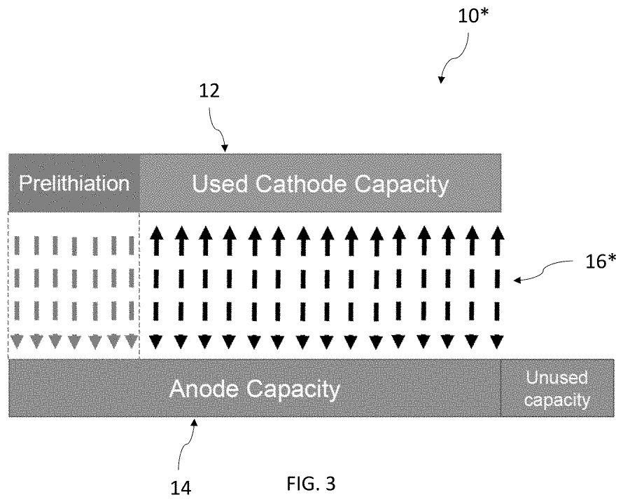

Referring to FIGS. 1-3, a schematic of a lithium-ion battery 10 is shown. Lithium-ion battery 10 generally includes a cathode 12 and an anode 14. Cathode 12 is configured to hold a specific capacity of lithium ions 16, 16* when at full capacity (i.e., in a new battery 10 or a regenerated or recycled battery 10*), as shown in FIGS. 1 and 3. However, as battery 10 is used, the amount of lithium ions within cathode 12 deteriorates or reduces to a used cathode capacity 18, as shown in FIG. 2. In various embodiments, cathode 12 may be formed of lithium cobalt oxide (LCO), lithium nickel cobalt manganese oxide (NCM), lithium manganese oxide (LMO), lithium iron phosphate (LFP), lithium nickel cobalt aluminum oxide (NCA), or other various materials, while anode 14 is typically formed of graphite, but may be formed of other various materials.

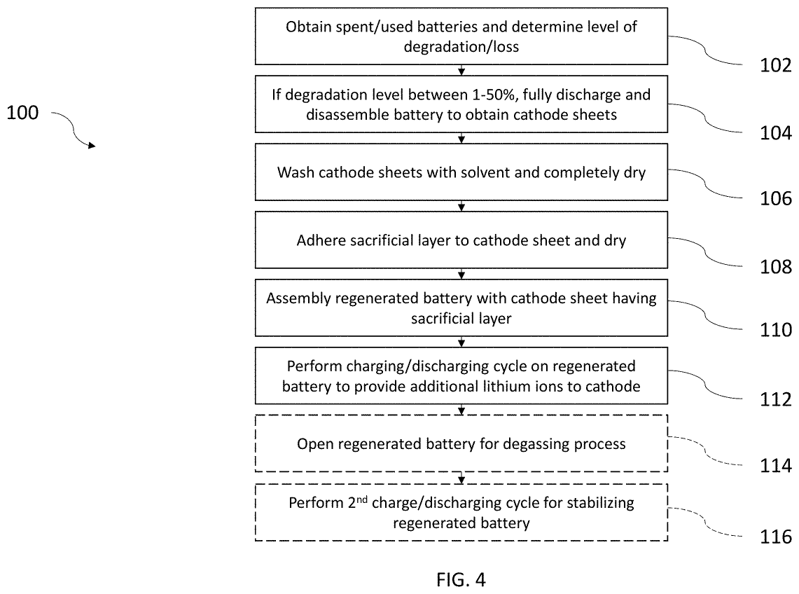

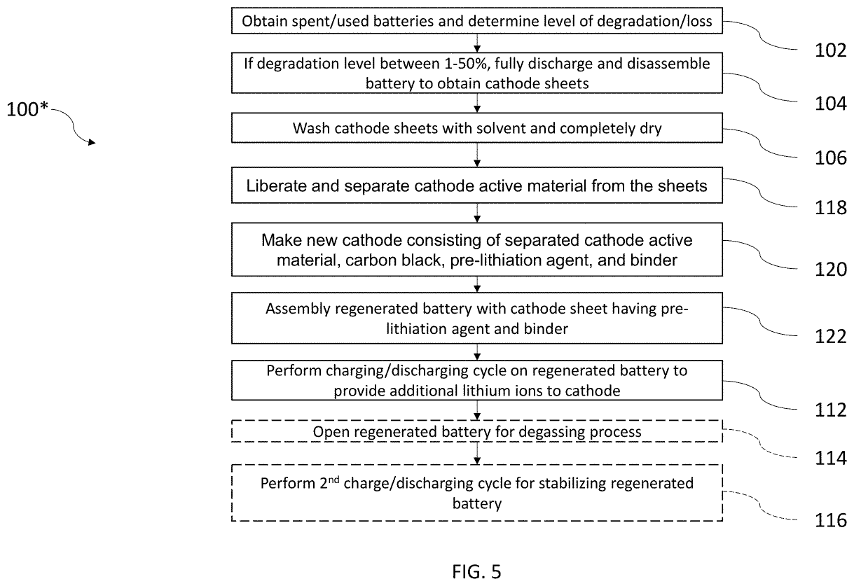

With reference now to FIGS. 4-8, in order to recycle or regenerate lithium-ion battery 10 from used capacity back to full or close to full capacity, an electrochemical-based cathode regeneration process 100, 100* as provided in the present application may be used. The electrochemical-based cathode regeneration process 100, 100* is used to regenerate the cathode in lithium-ion battery 10 back to full or close to full capacity by providing additional lithium ions via a sacrificial layer 20 (process 100) or a recycled or a new cathode (process 100*). Each of processes 100, 100* includes step 102 of obtaining spent or used lithium-ion batteries 10 and testing the remaining capacity of each battery 10 to determine the level of degradation or loss of lithium ions at cathode 12. If the degradation level is between 1-50% (or 50-99% of battery 10 remains useful), the processes continue at step 104 by fully discharging battery 10 and then disassembling battery 10 to obtain individual cathode sheet 12. Once discharged and disassembled, the process continues with step 106 in which cathode sheet 12 is washed out with a solvent, such as dimethyl carbonate (DMC), diethyl carbonate (DEC), ethyl methyl carbonate (EMC), or other various solvents, for example, to remove any salt and/or electrolyte residues. Once washed, cathode sheet 12 is completely dried or heat treated at different temperatures, such as 100° C., 200° C., 300° C., 400° C., and/or 500° C. or any temperature therebetween, for example, to remove any remaining surface impurities on cathode sheet 12.

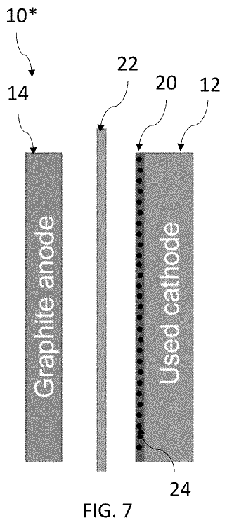

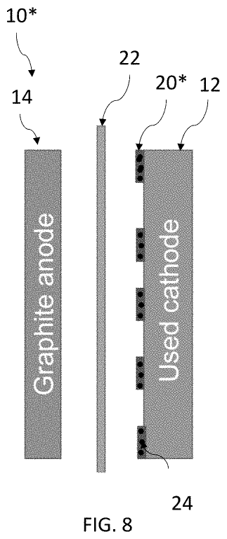

Once cathode sheet 12 is washed and dried, in various embodiments, the process may continue with step 108 in which sacrificial layer 20 (FIGS. 7 and 8) is adhered onto a surface of cathode sheet 12. In various embodiments, sacrificial layer 20 may be coated onto used cathode sheet 12 using a conventional slurry casting method or a thin film deposition method, such as chemical vapor deposition (CVD) or atomic layer deposition (ALD), for example.

For the conventional slurry casting method, sacrificial thin layer 20 may be formed using a slurry containing a pre-lithiation agent 24, a carbon additive such as powder carbon black, and a binder dissolved in a solution such as N-methyl-2-pyrrolidone (NMP) solution or deionized water. A sacrificial pre-lithiation agent is a lithium-containing chemical species that can be electrochemically decomposed at its decomposition potential to generate Li-ions. Various pre-lithiation agents 24 may include lithium peroxide (Li₂O₂), lithium azide (LiN₃), dilithium squarate (Li₂C₄O₄), dilithium oxalate (Li₂C₂O₄), dilithium ketomalonate (Li₂C₃O₅), dilithium di-ketosuccinate (Li₂C₄O₆), or other various pre-lithiation agents, while various binders may include polyvinylidene fluoride (PVDF), carbonxymethyl cellulose (CMC), styrene-butadiene rubber (SBR), or other various binders. The amount of sacrificial pre-lithiation agent 24 used in the slurry is determined based on the specific capacity of a pre-lithiation agent (i.e., approximately 545 mAh/g for lithium oxalate) and the degradation level of cathode sheet 12 and/or battery 10, while the amount of carbon additive and binder remain the same regardless of the degradation level.

In various embodiments, sacrificial layer 20 is approximately 0.01-5 microns thick and may be applied as a homogenous film or coating to cathode 12 (FIG. 7) or in a pattern (FIG. 8). After sacrificial layer 20 is applied to cathode sheet 12, cathode sheet 12 is dried in a vacuum or an inert environment at different temperatures, as such between 100-300° C. Once dried, process 100 continues with step 110 where cathode sheet 12 including sacrificial layer 20, 20*, new or regenerated anode sheets 14, and new separators 22 (FIGS. 7 and 8) being used to form a regenerated lithium-ion battery 10* (see FIGS. 7 and 8).

Alternatively, once cathode sheet 12 is washed and dried, in various embodiments, process 100* may continue with step 118 in which cathode material is liberated and separated from cathode sheet 12. In various embodiments, the cathode material is liberated and separated from cathode sheet 12 by cutting cathode sheet 12 into smaller pieces and putting said pieces into a solvent or water to dissolve the binder in cathode sheet 12. This process results in cathode active material and carbon black being liberated from the current binder and suspended in the solution. An ultrasonication process may be performed to facilitate the liberation process and separate agglomerated cathode active material. Once the cathode active material and carbon black are suspended in the solution, the solution may be placed in a centrifuge, whereby the cathode active material and carbon black are separated based on the differences in their density and/or hydrophobicity. The separated cathode active material is then fully dried in a vacuum oven at various temperatures, such as between 100° C. to 300° C. After the liberation and separation step 118, process 100* continues with step 120 where a new cathode 12* is made consisting of the separated cathode active material, carbon black, a pre-lithiation agent 24, and a binder.

In various embodiments, new cathode sheet 12* is formed by mixing cathode active material, which is lithium-ion deficient, with carbon black, a pre-lithiation agent 24, and a binder dissolved in a solution to create a cathode slurry. Various pre-lithiation agents may include lithium peroxide (Li₂O₂), lithium azide (LiN₃), dilithium squarate (Li₂C₄O₄), dilithium oxalate (Li₂C₂O₄), dilithium ketomalonate (Li₂C₃O₅), dilithium di-ketosuccinate (Li₂C₄O₆), or other various pre-lithiation agents, while various binders may include polyvinylidene fluoride (PVDF), carbonxymethyl cellulose (CMC), styrenebutadiene rubber (SBR), or other various binders. Using the conventional slurry casting method, composite cathode sheet 12* including a pre-lithiation agent is constructed. In various embodiments, new cathode sheet 12* may be formed of approximately 90 wt. % cathode active material, 4 wt. % pre-lithiation agent 24, 3 wt. % carbon black, and 3 wt. % binder. The amount of sacrificial pre-lithiation agent in the composition cathode sheet is determined based on the specific capacity of the pre-lithiation agent and the degradation level of cathode sheet 12 and/or battery 10, while the amount of carbon additive and binder remain the same regardless of the degradation level.

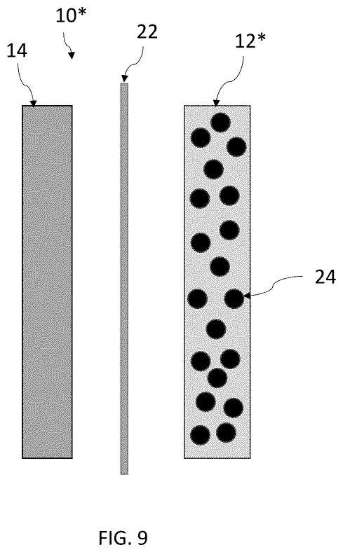

Once the new cathode is made, process 100* continues with step 120 where new cathodes 12*, new or regenerated anode 14, and new separators 22 (FIG. 9) being used to form a regenerated lithium-ion battery 10* (FIG. 9).

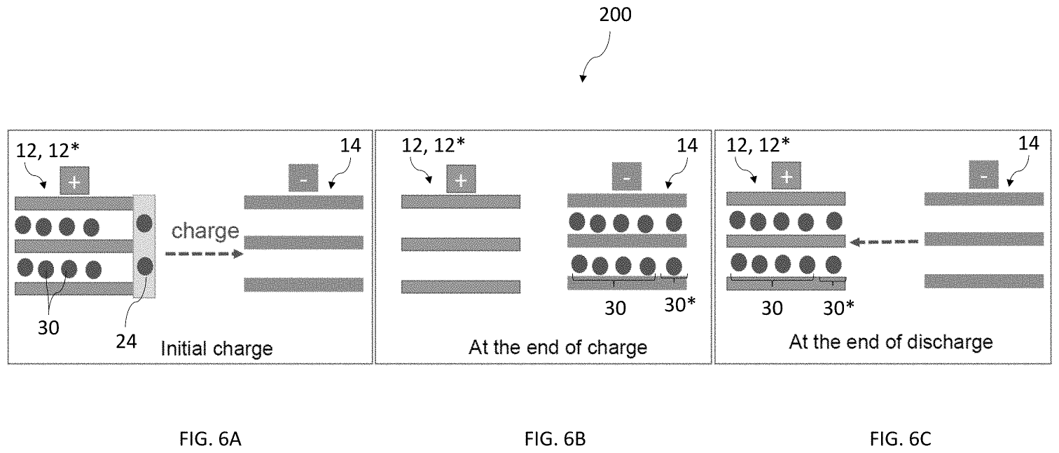

Referring now to FIGS. 4, 5, and 6A-6C, once assembled, processes 100, 100* continue with step 112 in which battery 10 undergoes a specialized formation cycle 200 (FIGS. 6A-6C) that induces decomposition of pre-lithiation agent 24 from sacrificial layer 20 or from within cathode sheet 12* at a specific voltage window to provide the additional lithium ions to cathode sheet 12, 12*. This cycle includes first fully charging battery 10 such that pre-lithiation agent 24 from sacrificial layer 20 or within cathode 12* decomposes and lithium ions 30 from cathode sheet 12, 12* and lithium ions 30* from pre-lithiation agent 24 are transferred to anode sheet 14. Once fully charged, battery 10 is fully discharged to provide lithium ions 30 and 30* back to cathode 12, 12* such that the lithium-ion capacity of cathode sheet 12, 12* returns to full capacity. In various embodiments, battery 10 undergoes approximately 3 to 10 charging/discharging cycles, and more specifically approximately 3 to 7 charging/discharging cycles, where the various cycles may be carried out at different voltage windows and different temperatures, such as temperatures between 20° C. to 100° C.

Processes 100, 100* may, in various embodiments, also include a de-gassing step 114 in which gas that may be produced during the decomposition reaction of pre-lithiation agent 24 may be removed from battery 10* and/or a step 116 of additional cycles 200 for stabilizing regenerated battery 10*.

In the foregoing specification, specific embodiments of the present disclosure have been described. However, one of ordinary skill in the art will appreciate that various modifications and changes can be made without departing from the scope of the disclosure as set forth in the claims below. Accordingly, the specification and figures are to be regarded in an illustrative rather than a restrictive sense. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued. No claim element herein is to be construed under the provisions of 35 U.S.C. 112(f) unless the element is expressly recited using the phrase “means for.”

1. A method for regenerating a cathode of a used lithium-ion battery, wherein the cathode of the used lithium-ion battery has a first level of lithium ions, the method comprising:
providing a pre-lithiation agent to the cathode;
assembling a regenerated lithium-ion battery using the cathode with the pre-lithiation agent; and
cycling the regenerated lithium-ion battery through at least one full charge event and at least one full discharge event at a first voltage window and a first temperature to provide the cathode of the regenerated lithium-ion battery with a second level of lithium ions, wherein the second level of lithium ions is higher than the first level of lithium ions.

2. The method of claim 1 further comprising, washing the cathode with at least one of a solvent and deionized water and drying the cathode prior to providing the pre-lithiation agent to the cathode.

3. The method of claim 1, wherein the pre-lithiation agent is provided to the cathode by adhering a sacrificial layer to the cathode.

4. The method of claim 3 further comprising, drying the cathode after adhering the sacrificial layer to the surface of the cathode.

5. The method of claim 1, wherein the sacrificial layer is a solid layer.

6. The method of claim 1, wherein the sacrificial layer is a patterned layer.

7. The method of claim 1 further comprising determining a level of degradation of the used lithium-ion battery prior to providing the pre-lithiation agent to the cathode.

8. The method of claim 1, wherein the at least one full charge event includes up to 10 full charge events and the at least one full discharge event includes up to 10 full discharge events, a number of full charge events being equal to a number of full discharge events, where each of the up to 10 full charge events and the up to 10 full discharge events occur at voltage windows and temperatures different from the first voltage window and the first temperature.

9. The method of claim 1, wherein the regenerated lithium-ion battery further includes an anode and a separator.

10. The method of claim 1, wherein the cathode is formed of at least one of lithium cobalt oxide (LCO), lithium nickel cobalt manganese oxide (NCM), lithium manganese oxide (LMO), lithium iron phosphate (LFP), or lithium nickel cobalt aluminum oxide (NCA).

11. The method of claim 1, wherein the second level of lithium ions includes at least one lithium ion from the pre-lithiation agent.

12. The method of claim 1, wherein the pre-lithiation agent is provided by forming the cathode with the pre-lithiation agent infused therein.

13. The method of claim 1, wherein the pre-lithiation agent includes one of lithium peroxide (Li₂O₂), lithium azide (LiN₃), dilithium squarate (Li₂C₄O₄), dilithium oxalate (Li₂C₂O₄), dilithium ketomalonate (Li₂C₃O₅), or dilithium di-ketosuccinate (Li₂C₄O₆).

14. A regenerated battery comprising:
a cathode having a sacrificial layer adhered to at least one surface of the cathode;
an anode positioned adjacent the cathode; and
a separator positioned between the anode and the cathode.

15. The regenerated battery of claim 14, wherein the sacrificial layer is positioned between the separator and the anode.

16. The regenerated battery of claim 14, wherein the sacrificial layer includes a pre-lithiation agent.

17. The regenerated battery of claim 16, wherein the pre-lithiation agent includes one of lithium peroxide (Li₂O₂), lithium azide (LiN₃), dilithium squarate (Li₂C₄O₄), dilithium oxalate (Li₂C₂O₄), dilithium ketomalonate (Li₂C₃O₅), or dilithium di-ketosuccinate (Li₂C₄O₆).

18. A regenerated battery comprising:
a cathode comprising a pre-lithiation agent;
an anode positioned adjacent the cathode; and
a separator positioned between the anode and the cathode.

19. The regenerated battery of claim 18, wherein the pre-lithiation agent is infused within the cathode.

20. The regenerated battery of claim 18, wherein the pre-lithiation agent is infused within a sacrificial layer adhered to the cathode.
